(19) United States
(12) Patent Application Publication
(10) Pub. No.: US 2007/0287474 A1
(43) Pub. Date: Dec. 13, 2007

(54) Method and system for location based communication service

(75) Inventors: William W. Jenkins, Wheaton, IL (US); Elizabeth A. Carter, Aurora, IL (US); Matthew W. Skeens, Cortland, IL (US); Steven L. Kierstad, Aurora, IL (US); Alireza Neyestani, Chicago, IL (US); Shiva Prasad Kalisetty, Aurora, IL (US); Jeffrey S. Fischman, Naperville, IL (US); Eric M. Linder, Downers Grove, IL (US)

Correspondence Address: FRANCISSEN PATENT LAW, P.C., 53 W. JACKSON BLVD, SUITE # 1320, CHICAGO, IL, 60604, US

(73) Assignee: Clarity Communication Systems, Inc., Aurora, IL (US)

(21) Appl. No.: 11/729,158

(22) Filed: Mar. 28, 2007

Related U.S. Application Data
(60) Provisional application No. 60/787,097, filed on Mar. 28, 2006.

(51) Int. Cl. H04Q 7/20

(52) U.S. Cl. 455/456.2

(57) ABSTRACT

A system and method for location based communication includes an access network for communication and a first access terminal configured to determine and report a position of the first access terminal. A location services server receives and stores the position report, compares the position of the first access terminal to a geographic zone definition, and sends a location match message if the position of the first access terminal is within the geographic zone definition. A communication server maintains a call domain, receives the location match message, and, in response, sets-up a call when the first access terminal is included in the call domain.

### CROSS-REFERENCE TO RELATED PATENT APPLICATIONS

This patent application claims the benefit of U.S. Provisional Patent Application No. 60/787,097, filed Mar. 28, 2006, herein incorporated by reference in its entirety for all purposes.

### FIELD OF THE INVENTION

This invention pertains to communications services.

### BACKGROUND OF THE INVENTION

Conventional push to talk (PTT) systems permit users of handheld communications devices, e.g. mobile telephones, to contact and communicate with one another through radio transmissions.

### BRIEF SUMMARY OF THE INVENTION

In an embodiment, a communication system is provided for location based communication that includes an access network configured to provide communication and a first access terminal in communication with the access network, where the first access terminal being configured to determine a position of the first access terminal and send a position report with the position of the first access terminal. The system also includes a location services server in communication with the access network, the location services server being configured to receive the position report and store the position of the first access terminal, where the location services server is further configured to maintain a geographic zone definition, compare the position of the first access terminal to the geographic zone definition, and send a location match message if the position of the first access terminal is within the geographic zone definition. A communication server in communication with the access network is configured to maintain a call domain, receive the location match message, and, responsive to the location match message, set-up a call when the first access terminal is included in the call domain. In a further refinement of this embodiment, the system further includes a second access terminal, where the second access terminal is in communication with the access network, the second access terminal being configured to determine a position of the second access terminal and send a second position report with the position of the second access terminal. In this refinement, the location services server is further configured to receive the second position report and store the position of the second access terminal, where the location services server is further configured to compare the position of the second access terminal to the geographic zone definition, and send a second location match message if the position of the second access terminal is within the geographic zone definition. The communication server is further configured in this refinement to receive the second location match message, and, responsive to the second location match message, add the second access terminal to the call if the second access terminal is included in the call domain. In a further refinement, the location services server is further configured to compare the position of the access terminal to the geographic zone definition, and send an out of zone message if the position of the access terminal is outside the geographic zone definition and the communication server is further configured to receive the out of zone message, and, responsive to the out of zone message, drop the access terminal from the call.

In another embodiment, a method for location based call set-up is provided that calls for determining a location for a first access terminal, determining whether the location for the first access terminal is within a geographic zone, and reporting that the first access terminal is within the geographic zone. The method also calls for, responsive to the report that the first access terminal is within the geographic zone, determining whether a user corresponding to the first access terminal is included in a call domain and, if the user corresponding to the first access terminal is included in the call domain, setting up a call that includes a second access terminal corresponding to at least one other user within the call domain and the geographic zone.

### BRIEF DESCRIPTION OF THE DRAWINGS

Certain exemplary embodiments of the present invention are described below with reference to the following figures, wherein:

FIG. 1 is a network architecture diagram illustrating one exemplary embodiment of a system for location based group communication service;

FIG. 2 is a control flow diagram illustrating an exemplary embodiment of a geographic location reporting process;

FIG. 3 is a control flow diagram illustrating an exemplary embodiment of a geographically based call, or geocall, setup process;

FIG. 4 is a control flow diagram illustrating an exemplary embodiment of a geographic call zone, or geozone, setup process;

FIG. 5 is a control flow diagram illustrating an exemplary embodiment of a geocall dynamic user add flow process;

FIG. 6 is a control flow diagram illustrating an exemplary embodiment of a geocall dynamic user drop process;

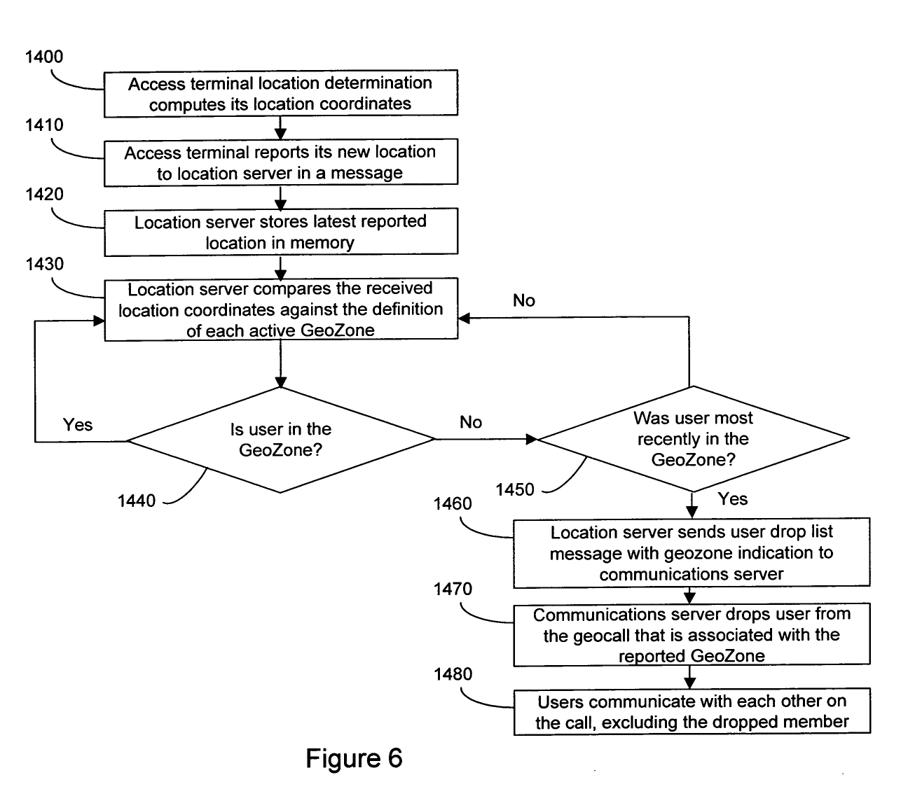

FIG. 7 is a control flow diagram illustrating an exemplary embodiment of a geocall dynamic geozone process;

FIG. 8 illustrates an exemplary embodiment of a geozone display; and

FIG. 9 illustrates an example of a dynamic geozone definition.

### DETAILED DESCRIPTION OF THE INVENTION

Communications systems at present support many different types of communication. The communication media may be voice, text, graphics, video, or multimedia. Each supports rich session control. For example, a voice call can be established by inviting a specified set of participants at call setup time, and when the call later ends, the communication session is complete. A call can be full duplex, supporting simultaneous speech in both directions between participants, or half duplex meaning that only one direction is allowed at a time.

Users are typically selected for participation simply by choosing their address, which is their unique identifier such as their phone number or internet address. There may be two participants on a call, or more than two, such as for a group call or conference call. There are many existing features that allow the set of participants to increase, decrease, or otherwise change membership during the life of a call. However, present systems are not able to originate or otherwise control calls based on the location of the users relative to geographic points or areas of interest. One example of an existing system is described in U.S. Pat. No. 7,031,700.

The invention described herein is generally directed toward dynamic call membership based on geographic location, e.g. control call membership based on a location. For example, consider an emergency site such as a building on fire. In this example, it may be useful to quickly establish communications between public safety personnel such as police, fire, and emergency medical services workers that arrive at the site. It would be advantageous to be able to originate a call that includes authorized personnel in the geographic area near the burning building. Present communications systems are generally not able to originate or otherwise dynamically control calls based on the location of the users relative to geographic points or areas of interest.

Location technology exists that allows a device to determine or otherwise become aware of its geographic location. Global Positioning Systems (GPS) devices can compute their location based on information streams received from earth orbiting satellites. Many cell phones include GPS capability. They often include additional location technology such as the ability to discover their location based on forward link trilateration of signals received from network cell towers. It is also possible to combine Geographic Information System (GIS) database information to identify device location relative to points on a map of the earth, roads, or other points of interest whose locations are stores in the database. However, these location technologies and associated GIS mapping databases are currently not utilized to improve the call setup problem.

One or more embodiments described herein provide the ability to control communication session membership based on the location of communication terminal devices. One embodiment features the ability to setup a call that includes users whose location falls within a geographic area called a “geozone” that is associated with the call. This is called a geocall. The geozone for a call can be selected from a list of predefined geozone definitions, or it can be defined by the user at call setup time. For example, a user could draw a square on a map displayed on a terminal device, derived from GIS map data stored on a location server. The area inside the square could be the geozone definition, and parameters that define the boundaries of the geozone are sent from the terminal device to the location server so that it knows the geozone definition.

A communications server performs the call setup. Data on the communication server defines the domain of users that are eligible to potentially be included in the call. For example there might be an attribute associated with each subscriber's data record that indicates the type of calls that the user can participate in, and the attribute might indicate “public safety” calls. In this case, if the domain of a call was “public safety,” then all users with the attribute set to “public safety” would be considered for membership in the call. This prevents non-authorized users from being invited to the call.

The communications server would query a location server, by sending a message to it, which requests the identity of all users in the call domain that are also within the geozone defined for the call. The location server sends a message to the communications server with the response. The communications server proceeds to setup the call with the membership provided by the location server.

In another embodiment the call membership can change dynamically during the call based on user locations, which are also dynamic. After a call is set up with its initial membership, users move and may enter or exit the geozone. They will be added or dropped from the call respectively.

When the call is setup, the location server produces the initial membership list as described above. For a dynamic geocall, it will also store an indication that the geozone is active. Each time a mobile reports its location to the location server, the location gets checked against all active geozones. If the reporting mobile has entered an active geozone, a notification message is sent to the communications server which proceeds to add the user to the in-progress call. If the location server finds that a mobile reporting its location has exited an active geozone, it reports the event to the communications server which removes the user from the call.

In another embodiment of the invention, the geozone definition can be dynamic. An initial geozone definition can be used for call setup as described above. When the call is setup, the location server produces the initial membership list as described above. It will also set up an alert trigger for the geozone. Later, during the call, the geozone can be redefined. If the newly defined geozone has different user membership compared to the previous definition, users will be correspondingly added or dropped from the call.

After a call is set up with its initial membership, the geozone may be redefined. The new geozone for the call can be selected from a list of predefined geozone definitions, or it can be defined by the user during the active call. For example, a user could draw a square on a map displayed on a terminal device, derived from GIS map data stored on a location server. The area inside the square could be the new geozone definition, and parameters that define the boundaries of the geozone are sent from the terminal device to the location server so that it knows the new geozone definition. The location server then checks the last reported location of all mobiles in the call domain against the new geozone definition. If a mobile is a new member of the call's geozone, the location server reports this to the communications server which adds the mobile to the call. If a mobile is no longer a member of the call's geozone, the locations server reports that to the communications server which removes it from the call.

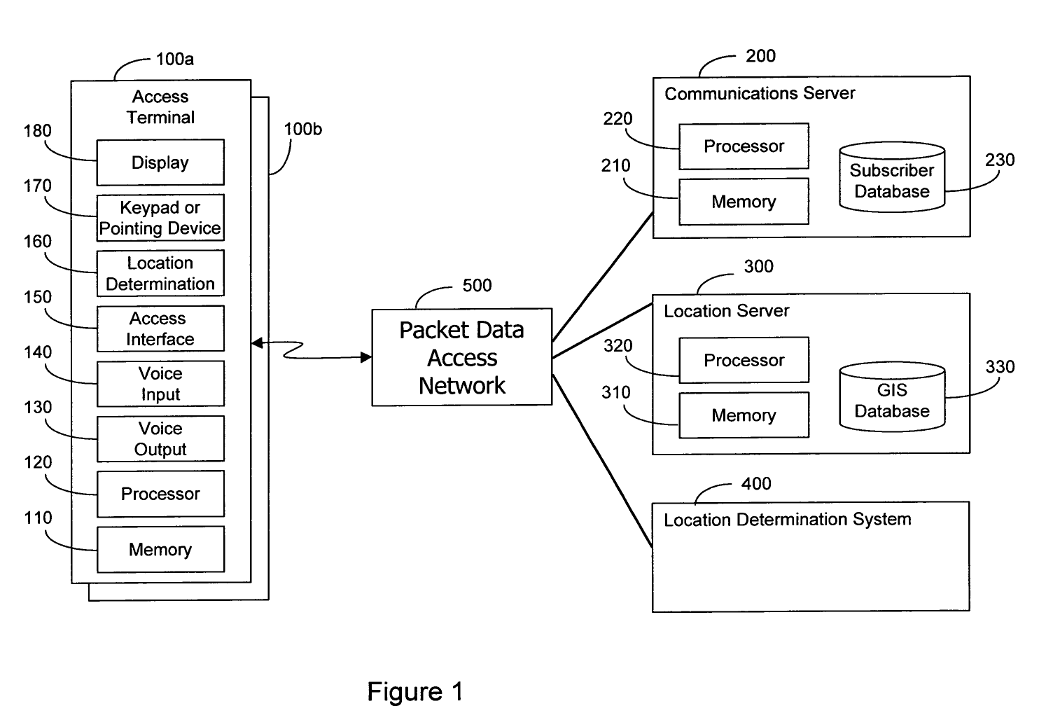

FIG. 1 is an architecture diagram illustrating one embodiment of a network architecture suitable for use with the present invention. In FIG. 1, one embodiment of an access terminal 100 is shown. Examples of an access terminal include a mobile telephone and a radio. In one exemplary embodiment, access terminal 100 includes a memory 110 for storing data and executable code, a processor 120 for executing applications stored in memory 110 as code, as well as a voice output 130 and voice input 140 for audio communication. This embodiment includes an access interface 150, a location determination module 160 for determining a location of the access terminal 100, a keypad or pointing device for user input, and a display for user output.

Further referring to FIG. 1, communications Servers 200 allow devices such as the access terminals 100 to communicate with each other. The communication server 200 contains a processor 220 that executes program instructions out of memory 210. It contains a subscriber database with information about each subscriber such as an address that uniquely identifies their access terminal 100, a list of access terminal capabilities, and a list of communication services that they are eligible to use. It controls call setup and teardown by sending the appropriate sequence of signaling messages over the packet data access network 500 to the access terminals 100 involved in a call. It also receives signaling messages from the access terminals 100. Program logic in the communications server memory 210 defines the types of calls it supports.

A call is an association between two or more access terminals, from an allowed call domain, for an interval of time. During the call, the access terminals on the call communicate with each other. There are many communications modes that can be used on a call including: half duplex, full duplex, two party, group call, voice media, text media, graphics media, video media, etc. Half duplex calls support communication in one direction at a time from the access terminal, over the packet data access network, and on to one or more other access terminals. Push to Talk (PTT) calls, which emulate “walkie-talkie” behavior, are an example of half duplex communications. The communication may pass through the communications server, or it may proceed directly to the receiving access terminal or terminals. Full duplex calls support communication in both directions simultaneously.

For voice media calls, the access terminal collects audible speech, and digitizes and encodes it using a voice input function 140 in the access terminal. The voice input function 140 may be a microphone connected to an analog to digital converter whose digitized speech samples are processed by the processor 120 using an algorithm stores in memory 110 to produce the encoded speech data. The encoded speech data is transferred over the packet data access network to the communications server and on to the receiving access terminal or terminals. Alternatively the data may be sent directly from the access terminal to the receiving access terminal or terminals. Each receiving access terminal decodes the data and converts it to audible speech using the voice output function 130. The voice output 130 function may be a processing algorithm stored in memory 110 that is executed by processor 120 to convert the encoded speech data back to digital voice samples which are presented to a digital to analog converter that produces an analog signal that drives a loudspeaker or ear piece speaker.

A call domain is a set of subscribers that are candidates that are eligible to be included in a call. The domain can be defined explicitly by a list that is stored in the communications server or access terminal. Or it might be defined by an attribute of the subscriber database records. For example, each subscriber record might contain a field identifying the user's membership in an organization such as “police” or “fireman.” The domain of police might be selected for a call so that call membership would be limited to subscribers who had the “police” attribute.

The access terminal 100 is generally a mobile device with a wireless access interface 150 that provides data connectivity with the packet data access network 500. The device can use a wired access interface 150 and it may also be stationary. The access terminal always includes one or more access interfaces 150, memory 110, and one or more processors 120. The processor executes program instructions stored in the memory and generally manages the activities of the access terminal. The access terminal may have any subset of the following functions, including all or none of: voice output 130, voice input 140, location determination 160, keypad or pointing device 170, and a visual display 180.

The location determination function 160 is capable of computing or otherwise obtaining the geographic coordinates such as latitude and longitude of the access terminal's current position. A location is a point in a 2 dimensional or 3 dimensional space. A 2D location refers to a point on the surface of the earth (latitude and longitude), and a 3D location refers to a point above or below the surface of the earth by some distance (latitude, longitude, height from 0 to H meters). In this document, the term “location” will refer to either 2D or 3D locations. There are many technologies available to determine position, and the location determination function 160 may utilize any such technology that can be reasonable integrated into the access terminal 100. For example, location determination function 160 may be a stand-alone Global Positioning System (GPS) receiver that works without assistance from an entity outside of the access terminal, except for the GPS satellites. In another alternative embodiment, location determination function 160 may be a GPS receiver that is assisted by communications over the packet data access network 500 with a location determination system 400. For example, CDMA cellular networks can use a Position Determining Entity (PDE), as defined by industry standards such as IS-801, to serve as the location determination system 400. The position determination system 400 may also compute the access terminal's 100 location based on information received from the access terminal 100 about information that the access terminal has received from cellular base stations, and return the location coordinates to the access terminal via the packet data access network 500 and the access interface 150. The reference “gpsOne Position-Location Technology”, gpsOne_{—}01/2006 (ACL0106) from Qualcomm Inc. has more information about location determination technology that may be used in some embodiments of the location determination function 160.

The keypad or pointing device 170 allows user input by pressing one more keys in sequence, or by selecting something on the display 180 and “clicking” or pressing an enter key. The display 180 can render text, graphics, or video that may be viewed by a user. It is common for a keypad to have “arrow” keys for up, down, left, and right movement of a selected feature of what is currently displayed. In this way the user can select an element on the display. Touch sensitive display technology may also be used as a pointing an selecting device such that a user can directly touch an area of the display that shows an item of interest such as an icon image and enable selection of that item.

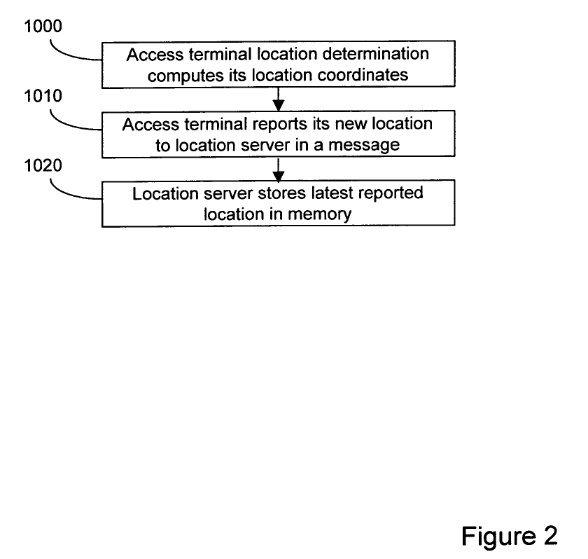

The location server 300 collects location information from access terminals 100 for which it is authorized to do so. It may prompt the access terminal to report its location by sending it a message over the packet data access network 500, or it may receive location reporting messages autonomously from the access terminal. The location reporting messages may come periodically, or aperiodically, for example based on events. FIG. 2 illustrates the steps for an access terminal to report its location to the location server. In the first step 1000, the access terminal computes it current location using it location determination capability which was described above. Then, in step 1010, the access terminal reports its location to the location server 300 by sending it a message containing the location coordinates. In step 1020, the location server stores the reported coordinates in its local memory.

Referring again to FIG. 1, the location server 300 learns the information it needs to communicate with the access terminals from the subscriber database 230. It learns the access terminal's address and permission information about accessing its location. The location server 300 may have its own copy of the subscriber database, or it may access the subscriber database 230 on the communication server 200 by exchanging request and response messages. The location server 300 contains a processor 320 that executes stored program instructions out of memory 310. The location server 300 stores a copy of received location information. It keeps at least the last one reported location for each access terminal. It may keep the last N reported locations for an access terminal, where N is a fixed number greater than 1. Alternatively, it may keep all locations reported from an access terminal in the last M seconds of time.

The location server 300 also distributes map images based on data in its Geographic Information System (GIS) database 330. The location server receives map requests from an access terminal 100 via the packet data access network 500. For example, an access terminal may ask for a map centered on a street address. The location server uses the GIS database to convert the street address into geographic coordinates. It then queries the GIS database for map image data for an area around the specified point. The image may contain data from one or more layers of the GIS database. For example, it may contain the “roads” layer and the “points of interest” layer. The location server would then combine the two to create one image file that shows the roads and points of interest in the area immediate to the address given in the map request. It sends the map image file to the access terminal to complete the request.

The location server 300 also processes geozone related requests. A geozone is a geographic area that is associated with a call. It can be an aggregation of one or more separated contiguous areas on a geographic map. It may receive a message with parameters that define a geozone area and be asked to store that information in its memory 310. It may receive a message that requests the list of users within a geozone. In this case it compares the coordinates of the last reported location for each access terminal against the boundaries of the geozone to determine if the user is inside or outside the geozone. It replies to the requestor with a geozone membership list message that contains the identity of each access terminal in the geozone. The location server may receive a request to keep track of an active geozone and report back all changes in user membership in the geozone. In this case, the location server will add that geozone to a list of all active geozones that it maintains.

The packet data access network 500 provides connectivity between the access terminals 100, communications server 200, location server 300, and location determination system 400. It allows the connected elements to send data packets to each other. A data packet contains payload data and addressing information that is sufficient for the packet data access network to transfer the packets to the intended destination element. An example packet data network uses Internet Protocol (IP) technology to transmit and route packets. The underlying physical layer of the packet data access network can use any suitable technology such as CDMA EVDO air interface, Ethernet, WiFi, WiMax, W-CDMA air interface, etc.

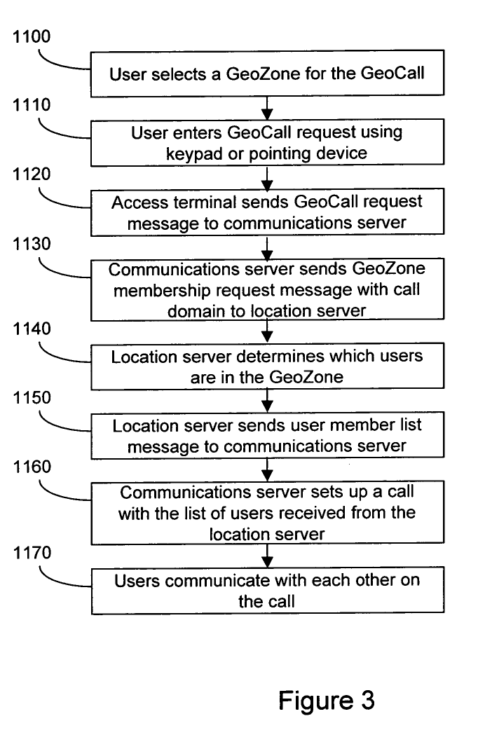

In the preferred embodiment, a Push to Talk (PTT) call is originated based on user locations relative to a geozone. An example of the utility of this capability involves public safety workers such as firemen at a burning building. The invention will allow the firemen at the site to immediately be put into communications with each other on a PTT call using cellular access terminals. FIG. 3 illustrates the steps used to set up a call. In the first step 1100 a geozone is defined for the call. The user may select a predefined geozone, for example from a list of geozones displayed on the access terminal display 180. Or the user may create a geozone definition for the call.

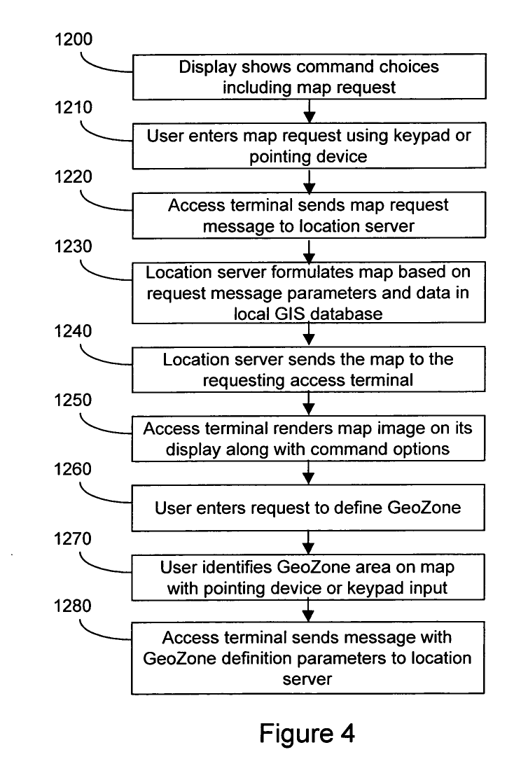

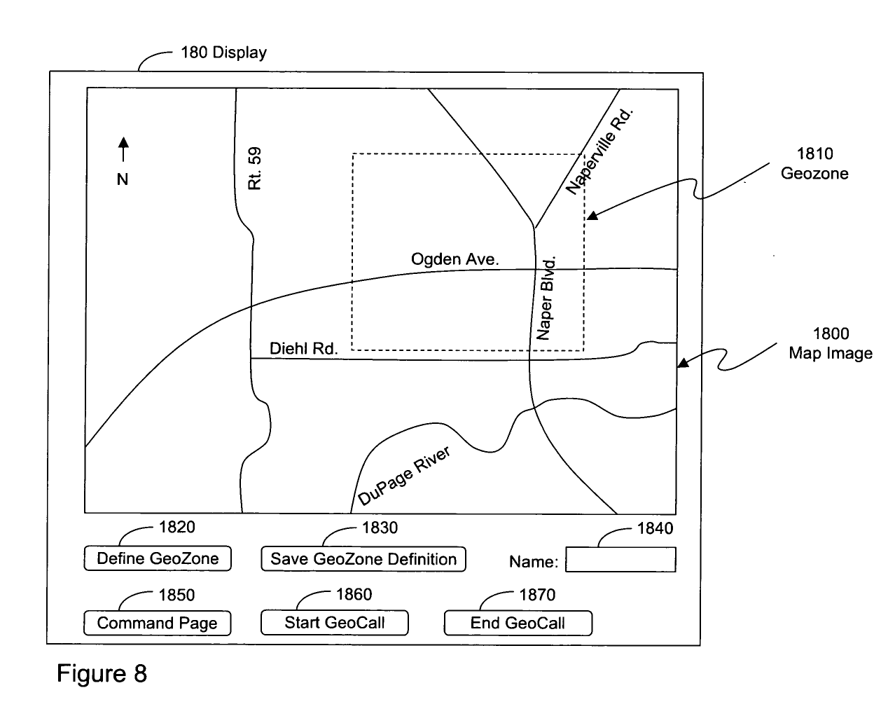

FIG. 4 illustrates the steps for creating a geozone definition. In the first step 1200, the display 180 presents the user with command choices including the opportunity to request a map. In step 1210 the user enters a map request using the keypad or pointing device. The request includes parameters used to specify what region to map such as a street address, geographic coordinates, points of interest, users whose location is of interest, and map scale or zoom level. In step 1220 the request is sent to the location server. In step 1230 the location server creates a map image file using map data in the GIS database, based on the location and zoom parameters presented in the request. In step 1240 the location server sends the map image file in a message to the requesting access terminal. In step 1250 the access terminal renders the map image on its display. It may also display command options to the user as illustrated in FIG. 8. In step 1260 the user requests to define the geozone, for example by pressing a key on the keypad or selecting the define geozone icon 1820 shown in FIG. 8. In step 1270 the user identifies the area bounded by the geozone, for example by pointing and “dragging” an area on the displayed map as illustrated by the dashed box 1810 in FIG. 8. In this instance, the 2D area in the dashed box is the new geozone. The user may optionally decide to save this geozone definition for possible additional future use by selecting the save geozone definition 1830 icon and entering a name for the geozone in text box 1840. In step 1280 the access terminal sends a message containing the geozone definition request and associated parameters to the location server 300.

Returning to FIG. 3, step 1110, the user requests a geocall by using the keypad or pointing device to enter the request into the access terminal. For example the user may select the start geocall icon 1860 in FIG. 8. The geozone for the call is that which was defined in step 1100. In step 1120 the access terminal sends the geocall request message to the communications server. The message includes the call domain definition which may be implicit, such as all subscribers to PTT service, or may be limited, for example to all subscribers with a certain attribute indicated in the request message. In step 1130, the communications server sends a geozone membership request with a specified call domain to the location server. In step 1140 the location server determines which users in the call domain are within the geozone boundaries by comparing the most recently reported location of each user against the geozone definition. In step 1150 the location server sends a user member list message to the communications server. Note that the originating user may or may not be included in the list. In step 1160 the communications server attempts to set up the call with the members of the list received from the location server. Some users may not be able to participate in the call due to being busy on another call, not having immediate access to the packet data access network, or some other reason. The call is set up with the available parties from the list of users in the geozone. In step 1170 the users on the call communicate with each other for the calls duration. They may then hang up to end their participation in the call using conventional call control techniques.

A geocall may include specific users, independent of their location, in addition to the users in the geozone. The originating user may identify such users in step 1110. For example, they may indicate that they themselves should be on the call even if they are not in the geozone. They may also specify other users to include in the call such as a supervisor or expert help that is needed to support workers at an emergency site. In step 1160 the communications server will include the specified users in the call setup processing along with the users in the geozone membership list received from the location server.

User's location need not necessarily come from the same access terminal that they use for communications. A user may have one access terminal with voice input 140 and voice output 130 capabilities, and they may be associated with a second access terminal with location determination 160 capability. The subscriber database 230 stores data that indicates the association of the user with each of their access devices. An example of the utility of this embodiment is when the user such as a police officer drives in an automobile with an Automatic Vehicle Location (AVL) device mounted in it. In this case, AVL device serves as an access terminal with location determination capability but without voice input or voice output capability. The user also has another access terminal with voice communications capability. The communications server subscriber database stores the association between the voice access terminal and the AVL device.

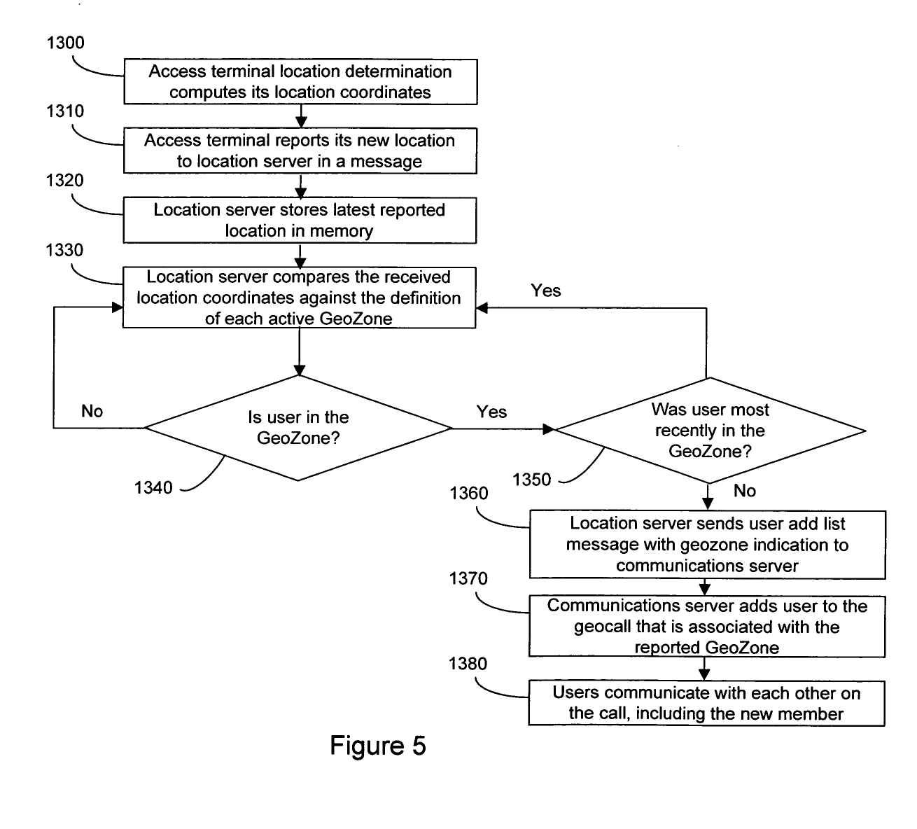

Another embodiment of the invention is to dynamically add a user to an in-progress call when they enter the geozone for the call. The precondition for this embodiment is that a geocall has already been setup as described above according to the logic flow illustrated in FIG. 3. In that flow, the message in step 1130 can include a parameter to indicate that the geozone is “active.” This is done for dynamic geocalls. FIG. 5 illustrates the logic flow for a dynamic user add. In the first step 1300 an access terminal computes its current location. It may do this for any number of reasons; it could have been configured to periodically update its location, or a location update can be requested by the location server in a request message, or a location update can be requested by the location server on behalf of another access terminal, or the need for an updated location could be based on a heuristic algorithm running or the access terminal processor 120 perhaps more frequently when the access terminal is near points or boundaries of interest such as geozone boundaries of which it is aware.

In step 1310 the access terminal reports the new location to the location server in a message. In step 1320 the location server stores the location in memory 310 because it always needs to keep track of the most recently reported location for each access terminal. In step 1330 the location server compares the received location coordinates against each active geozone definition, beginning with the first geozone on a list of all active geozones. In step 1340 the location server checks the user's current location against the geozone boundaries. If the user is not in the geozone the location server proceeds to step 1330 to check the next geozone in the list of active geozones. If there are no more active geozones then there is no change in membership and the processing is complete for this updated user location. Returning to step 1340 if the user is in the geozone the processing proceeds to step 1350 where the location server checks if the user was most recently in that geozone. For each user, the location server maintains a list of which geozones the user is currently in. Every time it compares the user's current location against an active geozone definition, it updates the list accordingly. If the user was most recently in the geozone processing proceeds to step 1330 where the next active geozone is checked if any remain. If the user was not previously in the geozone, then the user has just entered the geozone and processing proceeds to step 1360. The location server sends a user add list message to the communications server which indicates the user and the geozone that the user has just entered. In step 1370 the communications server uses the geozone identity to find which in-progress call needs to be updated. The communications server keeps track of the geozone associated with a dynamic geocall by storing the geozone identification along with other context information it maintains for an active call. It adds the designated user to the call. In step 1380 users on the call communicate with each other, including the newly added user.

Another embodiment of the invention is to dynamically drop a user from an in-progress call when they exit the geozone for the call. The precondition for this embodiment is that a geocall has already been setup as described above according to the logic flow illustrated in FIG. 3. In that flow, the message in step 1130 can include a parameter to indicate that the geozone is “active.” This is done for dynamic geocalls. FIG. 5 illustrates the logic flow for a dynamic user drop. In the first step 1400 an access terminal computes its current location. It may do this for any number of reasons; it could have been configured to periodically update its location, or a location update can be requested by the location server in a request message, or a location update can be requested by the location server on behalf of another access terminal, or the need for an updated location could be based on a heuristic algorithm running or the access terminal processor 120 perhaps more frequently when the access terminal is near points or boundaries of interest such as geozone boundaries of which it is aware.

In step 1410 the access terminal reports the new location to the location server in a message. In step 1420 the location server stores the location in memory 310 because it always needs to keep track of the most recently reported location for each access terminal. In step 1430 the location server compares the received location coordinates against each active geozone definition, beginning with the first geozone on a list of all active geozones. In step 1440 the location server checks the user's current location against the geozone boundaries. If the user is in the geozone the location server proceeds to step 1430 to check the next geozone in the list of active geozones. If there are no more active geozones then there is no change in membership and the processing is complete for this updated user location. Returning to step 1440 if the user is not in the geozone the processing proceeds to step 1450 where the location server checks if the user was most recently in that geozone. For each user, the location server maintains a list of which geozones the user is currently in. Every time it compares the user's current location against an active geozone definition, it updates the list accordingly. If the user was most recently not in the geozone processing proceeds to step 1430 where the next active geozone is checked if any remain. If the user was previously in the geozone, then the user has just exited the geozone and processing proceeds to step 1460. The location server sends a user drop list message to the communications server which indicates the user and the geozone that the user has just exited. In step 1470 the communications server uses the geozone identity to find which in-progress call needs to be updated. The communications server keeps track of the geozone associated with a dynamic geocall by storing the geozone identification along with other context information it maintains for an active call. It drops the designated user from the call. In step 1480 users on the call communicate with each other, but no longer including the dropped user.

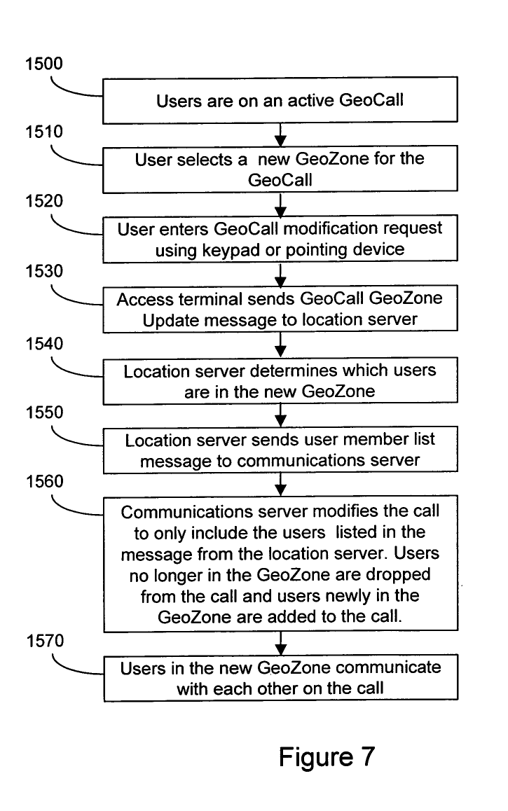

In another embodiment of the invention the geozone definition associated with a dynamic geocall is itself dynamic, moving or changing over time. In this dynamic geozone call the users can be mobile and the geozone itself is mobile. The logic flow for a dynamic geozone call is illustrated in FIG. 7. In the first step 1500 users are participating in a dynamic active geocall. In step 1510 a user can update the geozone definition for the call using any of the methods previously discussed. For example, a dispatcher can manually change the geozone definition by changing a location defining the geozone or graphically redefining the geozone. In step 1520 the user requests the call be modified and in step 1530 the request is sent to the location server. Alternatively, the geozone can be set to automatically update its geozone definition. In this case, when the call is originally setup, the parameters that define the nature of the automatically updating geozone definition are established. Each time the geozone definition is updated, the request to update the call is generated automatically.

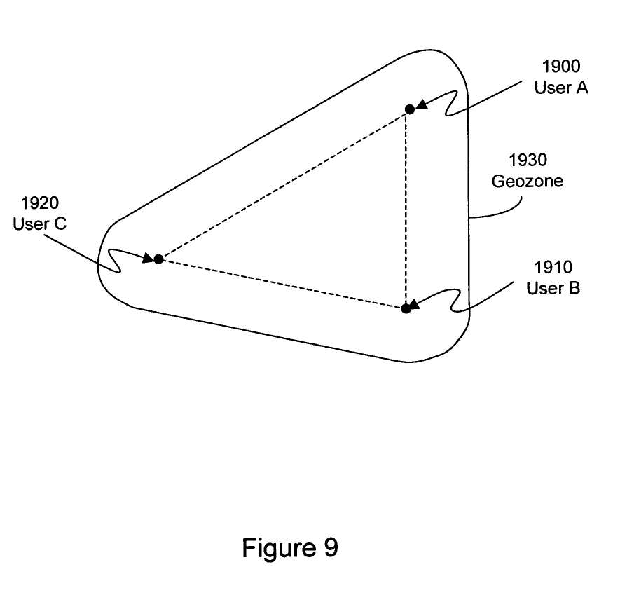

An example of the utility of this capability is a police pursuit situation where multiple police officers are chasing a suspect. A dynamic geozone call can be setup that designates a primary user or set of users assigned to the chase. The area swept out by the primary users can be the geozone. This could be the area contained by the primary user current locations possibly with an added margin of some distance. FIG. 9 is an illustration of an example dynamic geozone definition. The designated primary users are automatically included in the call. Any additional users entering the geozone area will be added to the call. In this example, as the pursuit moves, supporting officers are automatically added to the call. Officers not following the pursuit are automatically dropped from the call when the geozone leaves their vicinity.

Referring to FIG. 7, in step 1540 the location server determines which users in the call domain are in the newly defined geozone using methods described previously. The location server sends a user member list message to the communications server in step 1550. The message also indicates the geozone, which users are new to the geozone and which have exited. In step 1560 the communication server identifies the call based on the geozone identity. It adds the users that are indicated in the message to have entered the geozone, and it drops the users that are indicated to have exited the geozone. Communications on the call proceed, but with the new membership based on the new geozone definition.

By way of further description, an embodiment of a communication system in accordance with the present invention may be viewed as a Where2Talk (W2T) communication system that is directed toward providing mobile communications users, e.g. cellular telephone or radio users, with both immediate communication with other users through Push-to-Talk (PTT) and display information regarding the location of other users. The W2T system combines the communication immediacy and group call capabilities of Push-to-Talk (PTT) with Location-Based Services (LBS) to create a service that may be used by both enterprises and consumers, as well as government entities at the federal, state and local levels.

In one embodiment, Where2Talk includes access terminals, such as a handset client or web-based Dispatch Console, that feature a user interface. In one embodiment, the Where2Talk handset client or phone incorporates a Binary Runtime Environment for Wireless (BREW) application that that may permit users to perform certain functions, such as: Manage/view the contact list of users; View the contacts who are online and available; View a contact's location at-a-glance; Obtain a map, street address, and directions for each contact's location; Get directions to contact; or Make PTT calls based on where contact is located.

Also, in one embodiment of an access terminal, the Where2Talk Dispatch Console is a Windows PC based client application that allows users to perform certain dispatch functions, such as: See who is online and available; View the location of all contacts on full color maps; Make a PTT call from the PC to selected contacts based on where they're located; Dispatch addresses to mobile phones; mapping capabilities such as zoom, scroll, or best fit; or Maintain historical records of workforce locations.

In one embodiment, the Where2Talk service on an access terminal consists of a BREW application on a mobile phone or a PC-based Dispatch Console application. The PTT contact list on the mobile phone displays contacts on the main screen with their city/state location visible at-a-glance. In addition to being able to instantly call individuals and groups, the user may obtain a map of each contact's location, street address, and directions. Where2Talk's web-based Dispatch Console application enables users to view contacts on a map, see their online availability, select a group based on location, and may “Push-to-Talk” to them from the PC.

In a Where2Talk system, decisions on whether or not to call someone can be based on where the person is located. Enterprises can track their mobile workers via cell phone and PTT them from a mobile phone or PC. Enterprises adopting the service may realize productivity gains from improved communication and resource utilization. For consumers, the service can provide for family tracking and instant communications. Where2Talk's PTT contact list shows who is present and available and where they are located when the phone is powered on, which makes the service intuitive and easy-to-use.

In this embodiment, Where2Talk is generally compatible with 2.5G and 3G mobile data networks and works with existing packet data network without extensive network overhaul. This embodiment is generally compatible with GPS enabled BREW CDMA phones, such as the Kyocera KX2 phone. The system may be adapted to work on a variety of hardware and software platforms.

The following examples illustrate features of location based services directed towards groups that are determined by either fixed or floating locations, but should not be construed as in any way limiting the scope of the invention. In this example of a location-based services system, GeoTalk Groups are PTT groups whose membership is dynamically determined based on members' relative proximity to a specific location at the time of the call. A “Fixed” GeoTalk group is relative to a fixed point, such as a shopping mall. A “Floating” GeoTalk group is relative to the current location of the person originating the call. In this example, the GeoTalk Groups work as follows. Each PTT client samples and reports its own latitude and longitude location and reports its location, as part of the Location feature, at the origination of certain call types, as discussed further below. The PTT server associates location information with each subscriber for the Location feature, and no further location information is required for GeoTalk. When a user sets up a group, he/she can specify that the group is to be a GeoTalk group. In this embodiment, each GeoTalk group has a “Venue” attribute with two sub-attributes for the user to select: center and radius. One option for the “center” sub-attribute is Floating, where the center of the group or zone is determined relative to originator's location at time of call origination. This is the default case in the present example. The other option is Fixed, where the center is fixed relative to a fixed point specified by the user. The value of radius is a radial distance with respect to the center location, e.g. 1000 feet.

A Floating Center group changes the behavior of the client. At the origination of a call to a Floating Center group, the client must sample and report its own latitude and longitude location to the location services server. This may result in an additional delay prior to granting the initial talk beep.

The GeoTalk group also has changed the call set-up behavior in this example. The location services server typically has more up to date location information than a given client, so, in this example, the server is the decision maker when determining the parties to be included in a GeoTalk group call. The location services server chooses the Center based on the Center attribute, and if it is a Floating Center it expects a latitude and longitude location in the origination request. During the GeoTalk group call setup, the server compares the most recently reported latitude and longitude locations of the group members with the Center and only group members within the defined Radius from the selected Center are included as parties on the call. If no other users are within the Radius, then secondary treatment results—e.g. the message “No contacts in proximity, retry later” is output to the user.

If the originating user does not have the permission to receive the GeoPresence information of a member of the GeoTalk Group, then several alternative courses of action may be employed. This may or may not be a temporary situation. That member may enable permissions later on. That member should be offered as a choice to include in the group when the group list is being edited. While permission is disabled that member will not be included in calls originated to that GeoTalk Group by this originator. The lack of location info next to the member is the indicator that the member will not be included in GeoTalk group calls.

In this embodiment, users can select Fixed Centers for Venues as follows. The Fixed Center may be selected from a list of Favorites, e.g. a previously defined list of locations, that is pushed from the Dispatch Console. The list may be loaded at power-up or pushed whenever changes are saved on the Web. Alternatively, a Fixed Center can be established by the user from the handset by selecting a menu option that causes the current location to be sampled and recorded. In the latter case, the location sampled may be reported to the Dispatch Console as a new Favorite with a name provided by the user, or simply named with the lat/lon if the user does not provide a name.

In another embodiment, a “Man Down” feature may be provided. A special “Emergency Alert” GeoTalk group is defined and associated with the ‘*’ key. In one embodiment, this features works as follows. If the user holds down the * key for 4 seconds all users within the Emergency Venue are alerted. The candidate membership of this group is always the entire contact list of the originating user. The Center of the Emergency Venue is always Floating. The Radius defaults to 1 mile but can be changed on the Dispatch Console. When a user is alerted he/she is presented with an option to request a map and address of the user originating the alert.

The Dispatch Console is a web site accessible to certain users, such as push-to-talk (PTT) users, that allows them to view locations, manage lists and manage privacy preferences for location services enabled features. The Dispatch Console may be served from a Whereabouts Location Server but interfaces to the inTouch server may also be required.

At subscription time a user may optionally be assigned to an Administrator. The Administrator is, for example, another PTT user, identified by handle. Example Administrators may be a manager in an enterprise, or a parent in a family. If a user is assigned to an Administrator, then the following may occur. That user may not log in to the Dispatch Console, unless the user is an Administrator himself. The Administrator takes over all of the management and viewing capabilities for the user. An Administrator (A) may be assigned to another Administrator (B). In that case, A can only manage users assigned to A, and B can manage A but not users assigned to A (unless they are also explicitly assigned to B). If a user is not assigned to an Administrator then he/she may always log in.

The Dispatch Console allows the user to manage the following: Favorite locations that are pushed to the user's phone; Naming and Re-naming favorites. Also, privacy may be managed by selecting which Contacts (identified by handle) may receive location information for this user. For example, this could be a white list, e.g. a list of allowed callers, and/or a black list, e.g. a list of blocked callers. An interface between the Web Manager and a PTT server, which may be an embodiment of a call control server, may be used to populate location information in the PTT server in accordance to these privacy preferences. Also, the console may be used to specify the contacts that are to receive Emergency Alerts if a subset of the Contact list is preferred. This could be a white list and/or a black list

A user logged into the Dispatch Console can request a map display of any contact or Group of contacts for whom the user is allowed to receive GeoPresence information, e.g. location based information. A user logged into the Dispatch Console can request an updated sample and report in real-time for the location of any contact or group of contacts for whom the user is allowed to receive GeoPresence information. Updates will cause network traffic associated with contact all of the clients and are preferably limited in frequency to some configurable interval.

In an example of a network architecture for a where to talk (W2T) system, the system may include the following. W2T Handset Client Software—End users use the handset, which is one embodiment of an access terminal. This software is an application running in the handset on top of the platform provided in the handset device (e.g. BREW middleware, or Windows Mobile OS, or Java (J2ME), or Linux, or Symbian). W2T Dispatch Console PC Software—Used by dispatcher user of a console terminal, which is another embodiment of an access terminal. PTT Server—Push to Talk Server—acts as a call control server that provides call control for “walkie talkie” calls. Typically, the PTT server handles call set-up and routing of voice over IP streams between client devices for radio communications between users and amongst groups of users. An LBS Server—Location Based Services Server—acts as a location services server that collects locations from mobiles and distributes location related information to mobiles and other terminals. OAM&P Browser—Standard web browser; web pages are served by PTT and LBS servers.

The system may also interact with a telecommunications service providers network, which may include: Wireless Access Network—Provides packet data access to the mobile handsets. May include base stations, base station controllers, and other network gear such as Mobile Switching Centers (MSCs); PDSN—Packet Data Serving Node (for CDMA networks); GGSN—Gateway GPRS Support Node (for GSM networks); PDN—Packet data network—Carrier's private network of data routers, switches and related gear; DNS—Domain Name Server—Standard internet gear. Converts domain names (e.g. cnn.com) into IP addresses (e.g. 192.10.0.15); RADIUS—Remote Authentication Dial in User Service—Standard interface to billing server; AAA—Authentication Authorization and Access Server—Standard billing server for data; or PDE—Position Determining Entity—For CDMA; Does trilateration, etc. see TIA standard IS-801.

In one scenario, which demonstrates an embodiment of the GeoPresence feature described above, the LBS server obtains location information about mobiles, which is typically not visible to end users. The Mobiles, e.g. access terminals, report latitude & longitude (lat/lon) position info to the LBS server. A Mobile obtains self location through any of several methods, such as: GPS—mobile has a GPS receiver and obtains a fix direct from satellite signals. (Note that this method may not work indoors); AFLT—Advanced Forward Link Trilateration—mobile reports pilot signal ID and strength for the strongest 4 or cells it can receive, and reports into to PDE. PDE returns lat/lon based on trilateration of the pilot signal info if possible. If there is not enough info, e.g. mobile only received 1 pilot signal, the PDE returns location of the nearest cell tower. (Note that this method is not as accurate as GPS, but can usually be done indoors); or AGPS—Assisted GPS—Mobile reports pilot signal IDs and strengths to PDE as above. PDE signals back to mobile information about where to look for the nearest satellites. Mobile obtains location from GPS reception of satellite data, but much more quickly with the assistance from the PDE (e.g. 1 second instead of 100 seconds).

The mobile (client software) decides when to obtain a new location fix and when to report to LBS server. Due to the network traffic that may be generated by the activity of fixing and reporting a new location, it is preferable that this activity not be performed too often so that it does not consume network resources.

In this example, the client software displays a Contact list on the mobile handset. For example, after the user powers on the handset, the W2T client in the access terminal automatically starts up (on some specific mobiles the user may be required to start the application process). The User enters a login and password (preferably on the first login only). The W2T client registers with the PTT server (and LBS server). There is a secure authentication and authorization process between the client and each server. The PTT server returns contact (user) names, network access identities (NAI, unique numerical identity of the user), presence status of each contact, and more. The W2T client queries the LBS server for city location of each contact using NAI. In one embodiment, this can be simplified by picking the user names to have a fixed relationship; i.e. LBS name=PTT name+“000”. Even in this shortcut implementation, the mobile links user names between the two systems. The LBS server returns city names for the contact users. The W2T client displays contact list with presence icon and city name by each contact.

In one variation on this embodiment, the client application displays a map of user location on mobile device. On the contact list, the user scrolls to the desired contact and presses an OK button. In response, the mobile device displays a menu. The user selects the “map” offering from the menu. In response, the Mobile queries the LBS server for map data. Note that the LBS server will honor this request because the mobile has previously completed a successful authentication and authorization process as part of registration or, alternatively, due to a separate authentication with each request. The LBS server retrieves last reported location from the requested mobile. The LBS server queries the GIS database for map data. The LBS server returns the map data to the mobile for display.

The user may also make a PTT call with the mobile device. In one embodiment, on the contact list, the user scrolls to the desired contact or group and then presses and holds the talk button. The Mobile signals the PTT server with call origination information. The PTT server checks availability of each party on the call request and, if successful, completes the call. The Called party or parties hear a chirp (e.g. audible incoming call notification), hear incoming speech, and see GUI display with call information (e.g. caller's identity). When the caller releases the talk button, the “floor” is available and each party hears a chirp to indicate such (and their GUI indicates same). Any party can press and hold the talk button to request the floor. The server grants the floor to the next requestor and the call continues. (Priority floor arbitration is a roadmap feature.)

In an embodiment of the Dispatch Console, e.g. an access terminal used by a dispatcher, a user launches the client software. The client software may be obtained using a web browser to go to a specified URL. The Client software downloads automatically and the Client runs, querying the user for login and password, which preferably occurs on the first launch only. The Client registers to the PTT server and also the LBS server. There is a secure authentication and authorization process between the client and each server. The PTT server returns contact (user) names, network access identities (NAI, unique numerical identity of the user), presence status of each contact, and more. The W2T client queries the LBS server for city location of each contact using NAI, which is essentially the same process as for a handset client. In one example, the W2T client displays three panels on a graphical user interface: a contact list with presence icon and city name by each contact, a Map area (initially empty), and a PTT call control area.

The Dispatch Console, in this embodiment, can create a map showing the location of at least some members of the contact list. To create the map, the User clicks to create a check mark by each contact to be mapped, then clicks “create new map”. Note that multiple users can be mapped onto the same map. The client application in the Dispatch Console queries the LBS server for map data. Note that the LBS server will honor this request because the mobile has previously completed a successful authentication and authorization process as part of registration. The LBS server retrieves last reported location from each requested mobile. The LBS server queries the GIS database for map data for a best fit map that will include all requested users. The LBS server returns the map data and the client application on the Console displays it. The map has a GUI tab to allow the dispatch user to create multiple maps and switch between them with the tabs.

In one embodiment, the Dispatch Console is configured to make a PTT group call based on location. On the map displayed on the Dispatch Console, the dispatch user selects users to call by clicking on them (e.g. selecting their icons on the map) or sweeping a box around a set of them on the map. The client application puts the selected users into a list. The dispatch user then clicks and holds the talk button GUI icon. Alternatively, the user can check a toggle check box that causes the talk “button” to behave in toggle mode, which permits the user to click on and click off with no need to hold down the mouse button. In response, the Dispatch Console client signals the PTT server with call origination information. The PTT server checks availability of each party on the call request and, if successful, completes the call. The called party(ies) hear a chirp, hear incoming speech, and see GUI display with call information (e.g. caller's identity). When the caller releases the talk button, the “floor” is available and each party hears a chirp to indicate such (and their GUI indicates same). Any party can press and hold the talk button to request the floor. The server grants the floor to the next requestor and the call continues. One optional feature is to provide priority floor arbitration.

The Display Console client may provide a number of additional features. For example, click to send an address to a mobile (e.g. the user fills in an address or chooses from a history list and info is sent to mobile and the recipient is given the option to get driving instructions from their current location). The dispatch user may be provided with the detailed information for other users, e.g. select users on the map and get their current lat/lon, address, speed, timestamp of last location fix. The client may permit zoom in/out of the displayed map to resize the map. It may be possible to add and remove users from map. A best fit features provides a client that is able to resize a map to best include the currently selected users. The interface can permit contacts or a group on the contact list to be selected in order to place a PTT call.

In other embodiments, the client application (e.g. residing on a mobile or Dispatch Console) allows a user to specify a center and radius (e.g. another user and 2000 feet). The user can then press talk to place a call to all contacts within that area.

Additional information regarding TIA IS-801 is available at the following URLs:
http://3gpp2.com/Public_html/specs/C.S0022-0_v3.0_{—}121203.pdf
http://3gpp2.com/Public_html/specs/C.S0022-A_v1.0_{—}040617.pdf

In one example, a PDE, as discussed above, includes one or more of the following: a Base Station almanac—with the identity and location of each cell tower; a Satellite almanac—with the time/space coordinates of the orbits of the satellites of interest; and a Satellite Ephemeris data—“Fine tuning” information about the satellite locations (obtained from satellite reference tracking stations and made available to the PDE).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention. For example, while the servers described above are shown as separate devices, one of ordinary skill in the art will recognize that the servers described may be implemented as different processes on the same physical computing machine.

What is claimed is:

1. A communication system for location based communication, the system comprising:
an access network configured to provide communication;
a first access terminal in communication with the access network, the first access terminal being configured to determine a position of the first access terminal and send a position report with the position of the first access terminal;
a location services server in communication with the access network, the location services server being configured to receive the position report and store the position of the first access terminal, where the location services server is further configured to maintain a geographic zone definition, compare the position of the first access terminal to the geographic zone definition, and send a location match message if the position of the first access terminal is within the geographic zone definition; and
a communication server in communication with the access network, the communication server being configured to maintain a call domain, receive the location match message, and, responsive to the location match message, set-up a call when the first access terminal is included in the call domain.

2. The communication system of claim 1, wherein:
the system further including a second access terminal, where the second access terminal is in communication with the access network, the second access terminal being configured to determine a position of the second access terminal and send a second position report with the position of the second access terminal;
the location services server is further configured to receive the second position report and store the position of the second access terminal, where the location services server is further configured to compare the position of the second access terminal to the geographic zone definition, and send a second location match message if the position of the second access terminal is within the geographic zone definition; and
the communication server is further configured to receive the second location match message, and, responsive to the second location match message, add the second access terminal to the call if the second access terminal is included in the call domain.

3. The communication system of claim 1, wherein:
the location services server is further configured to compare the position of the access terminal to the geographic zone definition, and send an out of zone message if the position of the access terminal is outside the geographic zone definition; and
the communication server is further configured to receive the out of zone message, and, responsive to the out of zone message, drop the access terminal from the call.

4. The communication system of claim 1, the system including a client device in communication with the location services server, the client device being configured to permit a user to define the geographic zone definition.

5. The communication system of claim 4, where the geographic zone definition includes a geographic location and a radius from the geographic location.

6. The communication system of claim 5, where the geographic location includes at least one of a street address and geographic coordinates.

7. The communication system of claim 4, where the geographic location is defined with respect to a designated access terminal.

8. The communication system of claim 4, where the geographic zone definition is defined graphically by a user.

9. The communication system of claim 1, where the call domain includes at least one of a list of users associated with access terminals, a list of access terminals, and a user role associated with access terminals.

10. The communication system of claim 9, where the communication server is further configured to add a designated access terminal to a call regardless of whether the designated access terminal is within the geographic zone definition.

11. The communication system of claim 1, wherein:
the first access terminal is further configured to determine its position by sending a position determination request and receiving a position determination response, where the first access terminal determines the position of the first access terminal based on the position determination response; and
the communication system further includes a location determination server in communication with the access network, the location determination server being configured to receive the position determination request and send the position determination response containing position data corresponding to the first access terminal.

12. The communication system of claim 11, wherein:
the system further including a second access terminal, where the second access terminal is in communication with the access network, the second access terminal being configured to send a second position determination request, receive a second position determination response, determine a position of the second access terminal based on the second position determination response, and send a second position report with the position of the second access terminal;
the location determination server is further configured to receive the second position determination request and send the second position determination response containing position data corresponding to the second access terminal;
the location services server is further configured to receive the second position report and store the position of the second access terminal, where the location services server is further configured to compare the position of the second access terminal to the geographic zone definition, and send a second location match message if the position of the second access terminal is within the geographic zone definition; and
the communication server is further configured to receive the second location match message, and, responsive to the second location match message, add the second access terminal to the call if the second access terminal is included in the call domain.

13. The communication system of claim 1, wherein the first access terminal includes a global positioning system capability for determining, at least in part, the position of the first access terminal.

14. The communication system of claim 1, where the geographic zone definition changes during a call.

15. The communication system of claim 14, where the geographic zone definition is changed manually by a user.

16. The communication system of claim 14, where the geographic zone definition changes automatically.

17. The communication system of claim 16, where the geographic zone definition changes automatically in response to changes in position of the first access terminal.

18. A method for location based call set-up, the method comprising:
determining a location for a first access terminal;
determining whether the location for the first access terminal is within a geographic zone;
reporting that the first access terminal is within the geographic zone;
responsive to the report that the first access terminal is within the geographic zone, determine whether a user corresponding to the first access terminal is included in a call domain; and
if the user corresponding to the first access terminal is included in the call domain, setting up a call that includes a second access terminal corresponding to at least one other user within the call domain and the geographic zone.

19. The method for location based call set-up of claim 18, wherein the step of setting up a call further includes setting up the call to include at least one predetermined user from the call domain who is not within the geographic zone.

20. The method for location based call set-up of claim 19, where the predetermined user from the call domain who is not within the geographic zone is identified by a role that includes the predetermined user in the call domain.

21. The method for location based call set-up of claim 20, where the role is at least one of dispatcher and supervisor.

22. The method for location based call set-up of claim 18, where the step of determining a location for a first access terminal further comprises:
sending a request to a position determining entity for location data for a first access terminal; and
receiving the request for location data at the position determining entity, obtaining the location data for the first access terminal, and sending a response containing location data for the first access terminal.

23. The method for location based call set-up of claim 18, where the step of determining whether the location for the first access terminal is within a geographic zone further comprises:
reporting the location data for the first access terminal to a location services server; and
comparing the location data to the geographic zone data.

24. The method for location based call set-up of claim 18, wherein the method further comprises:
determining a location for a second access terminal;
determining whether the location for the second access terminal is within the geographic zone;
reporting that the second access terminal is within the geographic zone;
responsive to the report that the second access terminal is within the geographic zone, determine whether a user corresponding to the second access terminal is included in the call domain; and
if the user corresponding to the second access terminal is included in the call domain, adding the second access terminal to the call.

25. The method for location based call set-up of claim 24, wherein the method further comprises:
determining whether the location for the second access terminal is outside the geographic zone;
reporting that the second access terminal is outside the geographic zone;
responsive to the report that the second access terminal is outside the geographic zone, drop the second access terminal from the call.

26. The method for location based call set-up of claim 18, wherein the call domain includes at least one of a list of users, a role identifier for users, and subscribers in an operator's network.

27. The method for location based call set-up of claim 18, wherein the geographic zone includes at least one of a street address, a radius, a user location, a location defined by geographic coordinates, a graphically defined area, and a proximity to another user.

28. The method for location based call set-up of claim 18, wherein the geographic zone is graphically defined by a specific user.

29. The method for location based call set-up of claim 28, wherein the specific user is a dispatcher.

30. The method for location based call set-up of claim 28, wherein the specific user can also define the call domain.

31. The method for location based call set-up of claim 18, wherein the geographic zone changes during a call.

32. The method of claim 31, where the geographic zone is changed manually by a user.

33. The method of claim 31, where the geographic zone changes automatically.

34. The method of claim 33, where the geographic zone changes automatically in response to changes in position of the first access terminal.

35. A system for location based call set-up, the system comprising:
means for determining a location for a first access terminal;
means for determining whether the location for the first access terminal is within a geographic zone;
means for reporting that the first access terminal is within the geographic zone;
means for determining whether a user corresponding to the first access terminal is included in a call domain responsive to the report that the first access terminal is within the geographic zone; and
means for setting up a call that includes a second access terminal corresponding to at least one other user within the call domain and the geographic zone if the user corresponding to the first access terminal is included in the call domain.

36. The system for location based call set-up of claim 35, wherein the system further comprises:
means for determining a location for a second access terminal;
means for determining whether the location for the second access terminal is within the geographic zone;
means for reporting that the second access terminal is within the geographic zone;
means for determining whether a user corresponding to the second access terminal is included in the call domain responsive to the report that the second access terminal is within the geographic zone; and
means for adding the second access terminal to the call if the user corresponding to the second access terminal is included in the call domain.

37. The method for location based call set-up of claim 36, wherein the method further comprises:
means for determining the location for the second access terminal;
means for determining whether the location for the second access terminal is outside the geographic zone;
means for reporting that the second access terminal is outside the geographic zone;
means for dropping the second access terminal from the call responsive to the report that the second access terminal is outside the geographic zone.
